(19) United States
(12) Patent Application Publication
(10) Pub. No.: US 2015/0331430 A1
(43) Pub. Date: Nov. 19, 2015

(54) INSPECTION METHOD OF FLOW SENSOR, INSPECTION SYSTEM AND PROGRAM RECORDING MEDIUM WITH PROGRAM FOR INSPECTION SYSTEM RECORDED THEREON

(71) Applicant: HORIBA STEC, Co., Ltd., Kyoto-shi (JP)

(72) Inventors: Tadahiro Yasuda, Kyoto-shi (JP); Takashi Shirai, Kyoto-shi (JP)

(21) Appl. No.: 14/711,651

(22) Filed: May 13, 2015

(30) Foreign Application Priority Data
May 14, 2014 (JP) 2014-100973

(51) Int. Cl. G05D 16/20

(52) U.S. Cl. CPC G05D 16/2006

(57) ABSTRACT

In order to provide an inspection system of a flow sensor capable of charging an appropriate pressure in a flow path in response to the inspection target flow sensor and significantly reducing a waiting time until a start of an inspection, the inspection system is provided with: fluid resistances respectively provided for a plurality of respective branch flow paths branched in a downstream of an upstream side flow path where the inspection target flow sensor is provided: valves respectively provided for the respective branch flow paths; a fluid sensor having at least a part thereof being provided in an upstream side than each of the fluid resistances for measuring a pressure or a flow rate of the fluid; and a valve opening/closing control part configured to allow a plurality of the valves to be in opened states at the time of inspecting the inspection target flow sensor.

### TECHNICAL FIELD

The present invention relates to an inspection method of a flow sensor for inspecting at least a time delay contained in a flow rate value measured by the flow sensor, an inspection system and to a program recording medium with a program for the inspection system recorded thereon.

### BACKGROUND ART

In a measurement flow rate value outputted from a flow sensor, there may possibly occur a time delay with respect to an actual flow rate value in some cases. In order to check whether or not such a time delay occurs or adjust the flow sensor to cancel such a time delay, an inspection work of the flow sensor has been performed (see Patent Literature 1).

The inspection as to a time delay of a flow sensor is specifically performed as follows. First, a flow sensor to be calibrated (referred to as “inspection target flow sensor” hereinafter), a slow sensor as a reference (referred to as “reference flow sensor” hereinafter) and a fluid resistance for generating a predetermined pressure in a flow path are provided on the same flow path to thereby configure an inspection system and a flow rate of the fluid flowing in the flow path is changed. Next, at a time of the flow rate is changing, time series data of a measurement flow rate value outputted from the inspection target flow sensor and time series data of the reference flow rate value measured by the reference flow sensor are compared and the check is performed based on presence or absence of a phase difference, or, for example, parameters such as differential coefficients set in the inspection target flow sensor is adjusted so as to cancel the phase difference of the respective time series data.

Meanwhile, in the case where the inspection as described above is performed, in order not to include such as a noise unrelated to an output of each flow sensor, the inspection is started after a pressure in a flow path is sufficiently charged to stabilize a flow of fluid in the flow path.

However, in the case where a measurement range of the inspection target flow sensor is set in a small flow rate range, the flow rate of the fluid capable of flowing into the flow path via the inspection target flow sensor is very small compared to a volume of the flow path. Therefore, it takes time to charge the pressure in the flow path up to a pressure appropriate to start the inspection of the time delay.

Further, although the pressures in the flow paths capable of stably operating the inspection target flow sensors are different depending on the measurement ranges, the inspection is performed upon charging to substantially the same pressure regardless of the inspection target sensor in the current inspection system, and it cannot be said that the pressure is optimized in accordance with the inspection-target flow sensor.

### PRIOR ART DOCUMENT

### Patent Literature

### Patent Literature 1: JPA-Heisei 9-16268

### SUMMARY OF INVENTION

### Technical Problem

The present invention has been made in consideration of the problems as described above, and an object thereof is to provide an inspection method of a flow sensor, an inspection system and a program recording medium with a program for the inspection system recorded thereon, capable of charging an appropriate pressure in a flow path in accordance with an inspection target flow sensor and significantly reducing a waiting time until a start of an inspection.

### Solution to Problem

That is, a first aspect of the present invention is directed to an inspection method of a flow sensor for inspecting a time delay of a measurement flow rate value outputted from the inspection target flow sensor provided in a flow path structure equipped with an upstream side flow path and a plurality of branch flow paths branched in a downstream of the upstream side flow path, using an inspection system which includes: fluid resistances respectively provided for the respective branch flow paths; valves respectively provided for the respective branch flow paths; and a fluid sensor for measuring a pressure or a flow rate of fluid in the flow path structure. In this arrangement, the inspection method includes a valve control step for allowing a plurality of the valves to be in opened states at the time of inspecting the inspection target flow sensor based on the output of the fluid sensor.

Further, a second aspect of the present invention is directed to an inspection system used for inspecting a time delay of a measurement flow rate value outputted from an inspection target flow sensor provided in a flow path structure equipped with an upstream side flow path and a plurality of branch flow paths branched in a downstream of the upstream side flow path. The inspection system includes: fluid resistances respectively provided for the respective branch flow paths; valves respectively provided for the respective branch flow paths; a fluid sensor for measuring a pressure or a flow rate of fluid in the flow path structure; and a valve opening/closing control part configured to allow a plurality of the valves to be in opened states at the time of inspecting the inspection target flow sensor based on the output of the fluid sensor.

With this arrangement, since the fluid resistances and the valves are respectively provided on the respective branch flow paths, by allowing a plurality of the valves to be in opened states at the time of inspecting the inspection target flow sensor, it is possible to charge to a pressure appropriate for starting the inspection in a short time even though the flow rate of the fluid flowing in the flow path structure is small.

More specifically, by opening a plurality of the valves provided for the respective branch flow paths to thereby reduce a flow path resistance to the upstream side flow path, the state of the fluid in the flow path structure can be stabilized at a low pressure.

Thus, for example, in the case where a measurement range of the inspection target flow sensor is a small flow rate range and a set flow rate value is small and the flow rate flowing into the upstream side flow path is small compared to a volume of a flow path, the valve opening/closing control part increases the number of the opened valves among the respective valves so as to reduce the flow path resistance to thereby stabilize the fluid at a low pressure. Thus, it is possible to reduce a time for charging a pressure allowing an inspection of a time delay to start in the flow path structure.

Whatever the measurement range of the inspection target flow sensor may be, in order to be able to start the inspection of a time delay in a short time, the valve opening/closing control part may be configured to change a combination of the opening/closing states of the respective valves in accordance with a set flow rate value which is a target value of the flow rate of the fluid flowing at least in the flow path structure.

With this configuration, by change a combination of the opening/closing states by the valve opening/closing control part, a size of the flow path resistance with respect to the upstream side flow path can be freely changed to thereby stabilize the state of the fluid and the pressure capable starting the inspection can be changed.

For example, in the case where a measurement range of the inspection target flow sensor is a large flow rate range and a set flow rate value is large, it is sufficient that, the number of the closed valves among the respective valves is increased so that the flow path resistance to the upstream side flow path is increased so as to stabilize the fluid at a high pressure stabilizing the output of the inspection target flow sensor. Meanwhile, in the case where a measurement range of the inspection target flow sensor is small flow rate range, the state of the fluid can be also stabilized at a low pressure of the flow path structure by increasing the number of the respective opened valves.

And since the pressure required for the inspection of the time delay is charged in the flow path structure, by comparing the time series data of the flow rate value outputted from the inspection target flow sensor and the time series data of the measurement value of the flow rate or the pressure outputted from the fluid sensor, the time delay in the inspection target flow sensor is perceived and the inspection target flow sensor can be adjusted accurately.

Thus, it is possible to reduce a waiting time until an inspection related to a time delay can be started and the pressure can be adjusted to a pressure of stabilizing the output of the flow sensor as well. Thus, an inspection of a time delay can be realized in a short time with good accuracy throughout the flow rate range.

In order to be able to reduce the time required until the inspection of a time delay is started compared to a conventional one while securing an inspection accuracy, it is sufficient that, the valve opening/closing control part is configured to change a combination of the opening/closing states of the respective valves in a manner that, the smaller the set flow rate value is, the smaller the pressure of the fluid in the flow path structure becomes.

In the inspection of a time delay, it is not necessary that the measurement value outputted from the fluid sensor as a reference is exactly equal to an actual value, and it is sufficient that the measurement value shows even a similar behavior to a change of the actual flow rate. Therefore, in order to charge up to a pressure so as to be able to obtain a necessary and sufficient output for executing the inspection of a time delay from the fluid sensor and minimize the necessary time required until the inspection of the time delay is started and make it possible to reduce a total inspection time required for the inspection, it is sufficient that the valve opening/closing control part is configured to change the combination of the opening and closing states of the respective valves so that the pressure in the flow path structure becomes lower than a recommended usage pressure by which the fluid sensor can output a measurement value substantially the same as the actual pressure or actual flow rate of the fluid.

For example, upon charging a pressure suitable for an inspection of a time delay by the valve opening/closing control part, in order to be able to automatically calibrate a time delay of the inspection target flow sensor, it is sufficient to further include a flow sensor inspecting part that is configured to inspect the time delay of the measurement flow rate value outputted from the inspection target flow sensor, based on time series data of the measurement flow rate value outputted from the inspection target flow sensor and time series data of a measurement value of a pressure or a flow rate outputted from the fluid sensor.

As a specific aspect of an embodiment for adjusting the time delay of the inspection target flow sensor, there is exemplified that, the inspection target flow sensor is equipped with a sensing mechanism that is configured to output an electric signal corresponding to the flow rate of the fluid and a flow rate output part that is configured to output a measurement flow rate value based on a value indicated by the electric signal outputted from the sensing mechanism and a predetermined flow rate calculation formula. In this configuration, the flow rate calculation formula includes a term of a product of a differential value indicated by the electric signal outputted from the sensing mechanism and a differential coefficient which is a coefficient to be multiplied with the differential value, and the flow sensor inspecting part is configured to change the differential coefficient so that a phase difference between the time series data of the measurement flow rate value outputted from the inspection target flow sensor and the time series data of a measurement value measured by the fluid sensor becomes zero.

In order to control the flow rate of the fluid flowing in the upstream side flow path in the vicinity of the inspection target flow sensor to be able to realize a change of a flow rate required for an inspection of a time delay and improve the accuracy of the inspection of the time delay, it is sufficient that, the flow rate control device is configured of the inspection target flow sensor; the flow rate control valve provided on the flow path structure; and the flow rate control part for controlling the flow rate control valve so as to reduce a deviation between the set flow rate value and the measurement flow rate value outputted from the inspection target flow sensor.

In order to reduce a time required until the inspection is started while the inspection of a time delay can be performed in consideration of not only a flow rate but also characteristics of the fluid flowing in the flow path, it is sufficient that, the valve opening/closing control part is configured to change the combination of the opening and closing states of the respective valves in accordance with the set flow rate value and gas species of the fluid flowing in the flow path.

In order to be able to perform an inspection of a time delay accurately while using a flow sensor easily generating a time delay as the inspection target flow sensor and using a fluid sensor as a reference without a time delay in the fluid sensor thereby allowing to substantially reflect a change of the actual flow rate, it is sufficient that the inspection target flow sensor is a thermal type flow sensor and the fluid sensor is a pressure type flow sensor.

For example, in order to build the inspection system of the flow sensor of the present invention by after-fitting using the flow rate control devices and the like respectively provided on the branch flow paths of such as an existing semiconductor manufacturing system, it is sufficient that, a program is used for inspecting a time delay of a measurement flow rate value outputted from an inspection target flow sensor provided in a flow path structure equipped with an upstream side flow path and a plurality of branch flow paths branched in a downstream of the upstream side flow path, and used for the inspection system of the flow sensor, the inspection system including: fluid resistances respectively provided for the respective branch flow paths; valves respectively provided for the respective branch flow paths; and a fluid sensor for measuring a pressure or a flow rate of fluid in the flow path structure, the program permitting a computer to exhibit a function as a valve opening/closing control part configured to allow a plurality of the valves to be in opened states at the time of inspecting the inspection target flow sensor based on the output of the fluid sensor, and the program for the inspection system of the flow sensor should be installed in the existing system. Note that this program may be a program that is electronically distributed, or a program that is recorded on a program recording medium such as a CD, DVD and a flash memory.

### Advantageous Effects of Invention

Thus, according to the present invention, at the time of inspecting a time delay of the inspection target flow sensor, a plurality of the valves respectively provided on the plurality of branch flow paths are opened to thereby reduce the fluid resistance to the upstream side flow path, and the pressure in a table state of the fluid required for starting the inspection relating to a time delay can be set small. Therefore, since the pressure at the time of the fluid being in a stable state is low even though the flow rate flowing in the flow path structure is small, charging of the pressure is completed and the time required until the inspection of a time delay is started can be significantly reduced.

### BRIEF DESCRIPTION OF DRAWINGS

FIG. 1 is a schematic diagram entirely showing a semiconductor manufacturing system and an inspection system according to an embodiment of the present invention;

FIG. 2 is a schematic diagram showing an inspection system portion of a flow sensor configured in the semiconductor manufacturing system in the same embodiment;

FIG. 3 is a schematic graph showing states before and after adjustment of a time delay in the same embodiment;

FIG. 4 is a flowchart showing an operation of the inspection system of the flow sensor in the same embodiment;

FIG. 5 is a schematic diagram entirely showing a semiconductor manufacturing system and an inspection system according to a different embodiment of the present invention; and

FIG. 6 is a schematic diagram showing an inspection system portion of a flow sensor configured in the semiconductor manufacturing system in the different embodiment.

### DESCRIPTION OF EMBODIMENTS

The following describes an inspection system 100 of a flow sensor pertaining to one embodiment of the present invention with reference to the accompanying drawings.

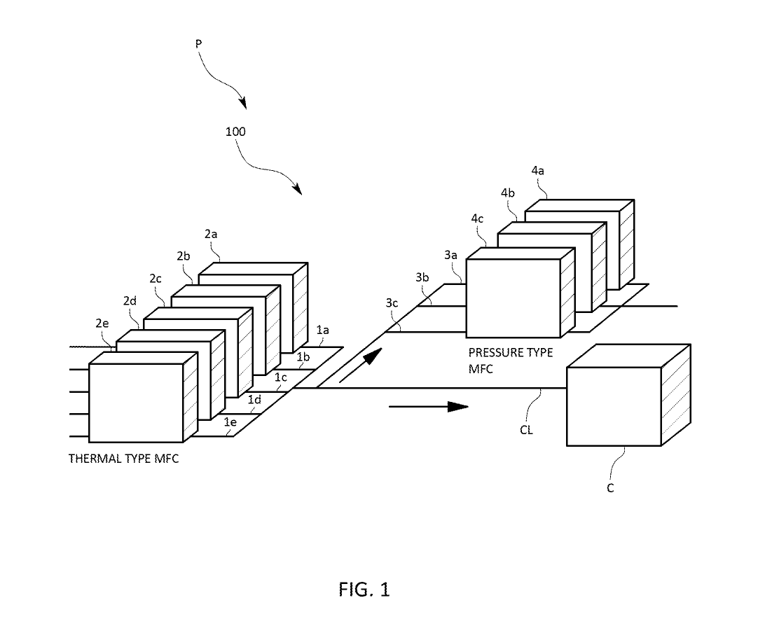

As shown in FIG. 1, an inspection system 100 for inspecting a flow sensor (referred to as “flow sensor inspection system” hereinafter) of the present embodiment, for example, serving as a part of a semiconductor manufacturing apparatus P is intended to be used for an inspection relating to a time delay of a flow sensor provided in a flow rate control device executing a flow rate control of various kinds of gas to be supplied to a process chamber C thereof.

In specific, this semiconductor manufacturing apparatus P is equipped with: gas supply lines 1a to 1e (collectively referred to as “gas supply line 1” hereinafter) in which various kinds of gas for semiconductor manufacturing such as, for example, process gas and etching gas flows; a chamber line CL and inspection lines 3a to 3c (collectively referred to as “inspection line 3” hereinafter) provided in parallel and branched on a downstream side of a joining point where the gas supply lines 1 are joined; flow rate control devices 2a to 2e (collectively referred to as “inspection target flow rate control device 2” hereinafter) each having an inspection target flow sensor FS provided on each of the gas supply lines 1; flow rate control devices 4a to 4c each serving as a reference (also, collectively referred to as “reference flow rate control device 4” hereinafter) respectively provided on the inspection lines 3; and an information processing unit 5 for executing an inspection related to a time delay of each of the inspection target flow sensors FS by allowing each of the flow rate control devices to execute a predetermined operation. Note that, each inspection line 3 and each reference flow rate control device 4 are also used for checking or correcting as to whether or not an accurate flow rate control is performed by each inspection target flow rate control device 2 and whether or not the flow sensor FS of the flow rate control device 2 shows an accurate flow rate value. During such as a check or calibration as to a flow rate value, it is performed in a state that one of the inspection target flow rate control devices 2 and only one of the reference flow rate control devices 4 are connected in a one-to-one relationship to form a single flow path.

The inspection target flow rate control device 2 is a so-called thermal type mass flow controller and the inspection target flow sensor FS is a thermal type flow sensor.

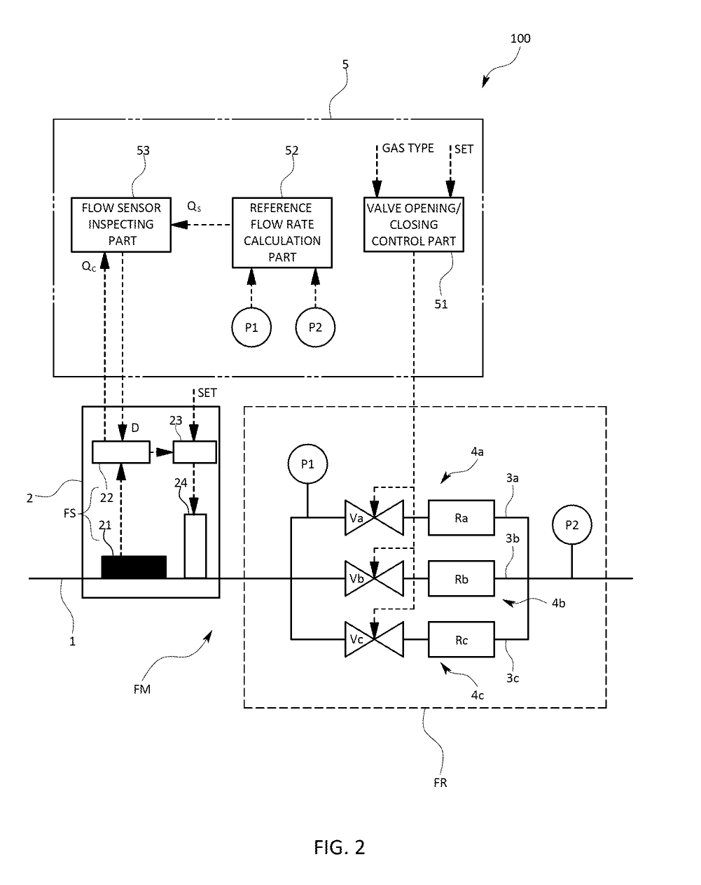

Further, the reference flow rate control device 4 is a so-called pressure type mass flow controller which is equipped with: valves Va, Vb and Vc; laminar flow elements Ra, Rb and Rc serving as the fluid resistances; an upstream side pressure sensor P1 provided on the upstream side of the laminar flow elements Ra, Rb and Rc; and a downstream side pressure sensor P2 provided on the downstream side of the laminar flow elements Ra, Rb and Rc. Note that, although only the pressure sensors used for inspecting a time delay are shown in FIG. 2, each of the inspection lines 3 is provided with two pressure sensors in practice respectively in the upstream side and the downstream side of each of the laminar flow elements Ra, Rb and Rc.

Then, the flow sensor inspection system 100 uses the respective reference flow rate control devices 4a, 4b and 4c and it is configured as a flow path resistance adjustment mechanism FR to the gas supply lines 1. In other words, the flow sensor inspection system 100 does not include the inspection target flow rate control device 2 and inspection target flow sensor FS. At the time of inspecting a time delay, the information processing unit 5 controls an opening/closing valve (not shown) for switching a flow path connection so that only one of the inspection target flow rate control devices 2a to 2e is connected to each of the reference flow rate control devices 4a, 4b and 4c.

That is, only one inspection target flow sensor FS and the flow sensor inspection system 100 are extracted from the semiconductor manufacturing system P in FIG. 1 and the extracted portions are shown in FIG. 2. As to be understood From FIG. 2, the flow sensor inspection system 100 of the present embodiment is intended to calibrate an inspection target flow sensor FS provided in the flow path structure FM equipped with the gas supply line 1 serving as an upstream side flow path and the inspection lines 3a, 3b and 3c serving as a plurality of branch flow paths branched in the downstream of the upstream side flow path. Then, the inspection system 100 of the present embodiment is configured to appropriately calibrate a time delay while commonly using various equipment provided in the flow path structure FM for the purpose other than the inspection of a time delay.

In other words, as shown in FIG. 2, the inspection system 100 is intended to execute an inspection related to a time delay as to a thermal type flow sensor FS in the thermal type flow rate control device 2 provided on one of the gas supply lines 1 serving as the upstream side flow path. This flow rate control device 2 is configured of an inspection target flow sensor FS; a flow rate control valve 24 for controlling a flow rate of fluid flowing in the gas supply line 1; and a flow rate control part 23 for controlling an open degree of the flow rate control valve 24 so as to reduce a deviation between a measurement flow rate value outputted from the flow sensor FS and a set flow rate value SET which is a flow rate target value of fluid flowing in the gas supply line 1. This flow rate control part 23 is intended to control the opening degree of the flow rate control valve 24 for forming a flow rate change of the fluid required during the inspection of a time delay. Note that, the functions of the flow rate output part 22 and the flow rate control part 23 are exhibited by executing a program using, for example, a microcomputer and the like.

Further, the inspection target flow sensor FS includes: a sensing mechanism 21 for outputting an electric signal corresponding to a flow rate of the fluid; and a flow rate output part 22 for outputting a measurement flow rate value based on a value of the electric signal outputted from the sensing mechanism 21 and a preset flow rate calculation formula. The sensing mechanism 21 includes two bridge circuits configured by winding two heat-sensitive resistance elements around a U-shaped capillaries provided so as to be branched from a flow path (not shown) to thereby apply a voltage so that the temperature of each of the heat-sensitive resistance elements becomes constant. Thus, the sensing mechanism 21 is configured to produce a voltage value which is varied in accordance with a flow rate of the fluid to be applied to each of the heat-sensitive resistance elements so that this voltage value is outputted to the flow rate output part 22.

The flow rate output part 22 is intended to output a flow rate based on each of the voltage values outputted from the sensing mechanism 21 using a predetermined formula. Since there is a large time delay between the voltage value outputted from the sensing mechanism 21 and an actual flow rate of the fluid, instead of converting the voltage value per se obtained at the present time to a measurement flow rate value, the flow rate output part 22 is configured to be able to predict a value close to a current actual flow rate value from the value obtained at the present time so that the predicted value is outputted.

That is, the flow rate calculation formula used in the flow rate output part 22 includes a differential term so that a time delay is recovered. More specifically, the flow rate calculation formula includes a term of a product of a differential value of a value indicated by the electric signal outputted from the sensing mechanism 21 and a differential coefficient which is a coefficient to be multiplied to the differential value. The inspection system 100 of the present embodiment is configured so that the differential coefficient is set to an appropriate value.

Then, the inspection system 100 in the present embodiment includes: the valves Va, Vb and Vc respectively provided on the inspection lines 3a, 3b and 3c serving as a plurality of branch flow paths branched in the downstream side of the gas supply line 1; the laminar flow elements Ra, Rb and Rc; at least one of the upstream side pressure sensors P1; at least one of the downstream side pressure sensors P2; and the information processing unit 5. Note that, in the present embodiment, the upstream side pressure sensor P1 shown in FIG. 2 corresponds to a fluid sensor recited in claims.

The information processing unit 5 is a so-called computer including a CPU, a memory, input/output means, A/D and D/A converters and the like, which is configured so that at least the functions of a valve opening/closing control part 51, a reference flow rate calculation part 52 and a flow sensor inspecting part 53 as shown in FIG. 2 are exhibited by executing a program for the flow sensor inspection system stored in the memory.

The valve opening/closing control part 51 is intended to control the opening/closing operation of each of the valves Va, Vb and Vc respectively provided on the inspection lines 3a, 3b and 3c and to control the number of the laminar flow elements Ra, Rb and Rc acting as the fluid resistances to the gas supply line 1. In this configuration, at least one of the characteristics as the fluid resistances of the respective laminar flow elements Ra, Rb and Rc is differentiated to be able to cope with the check and calibration of the measurement flow rate value per se outputted from the inspection target flow sensor having various measurement ranges as well.

More specifically, the valve opening/closing control part 51 is configured to change the combination of the opening/closing states of the respective valves Va, Vb and Vc in accordance with the set flow rate value SET which is a flow rate target value of the fluid flowing in the gas supply line 1 and a kind of the gas flowing in the flow path at a time of inspecting a time delay. In other words, the valve opening/closing control part 51 changes the combination of the laminar flow elements Ra, Rb and Rc acting as the fluid resistances on the gas supply line 1 among the respective laminar flow elements Ra, Rb and Rc by controlling the combination of the opening/closing states of the respective valves Va, Vb and Vc to thereby change the value of the fluid resistance acting on the gas supply line 1. In the present embodiment, the valve opening/closing control part 51 has a table presetting the combination of the opening/closing states of the respective valves Va, Vb and Vc corresponding to the set flow rate value SET and a kind of the gas to thereby determine which valves Va, Vb and Vc should be opened or closed with reference to this table.

In the case of paying attention to the set flow rate value SET, the valve opening/closing control part 51 is configured to control the opening/closing states of the respective valves Va, Vb and Vc in a manner that, the smaller the set flow rate value SET for inspecting a time delay is, the smaller the fluid resistance acting on the gas supply line 1 is reduced, so as to stabilize the state of the fluid in the gas supply line at a low pressure. In this context, the phrase “to stabilize the state of the fluid” means that there is a predetermined correlation between, for example, a change in opening degree of the flow rate control valve 24 and the actual flow rate of the fluid and that the actual flow rate can be changed by a desired waveform. In this case, it is not necessary that the actual flow rate accurately follows in a waveform of the set flow rate value SET but it is sufficient so long as the shapes in the case of graphing the opening degree of the valves and the actual flow rate with time lapse are essentially the same or the graphs are coincident by shifting in parallel in the direction of the time axis and scaling in the direction of the output axis.

The reference flow rate calculation part 52 is intended to calculate the flow rate of the fluid flowing in the gas supply line by a pressure type flow rate calculation formula based on the pressure values outputted from the upstream side pressure sensor P1 and the downstream side pressure sensor P2. Since this flow rate calculation formula is based on the pressures, there occurs almost no time delay and it can be considered that there occurs no phase difference with respect to the actual flow rate.

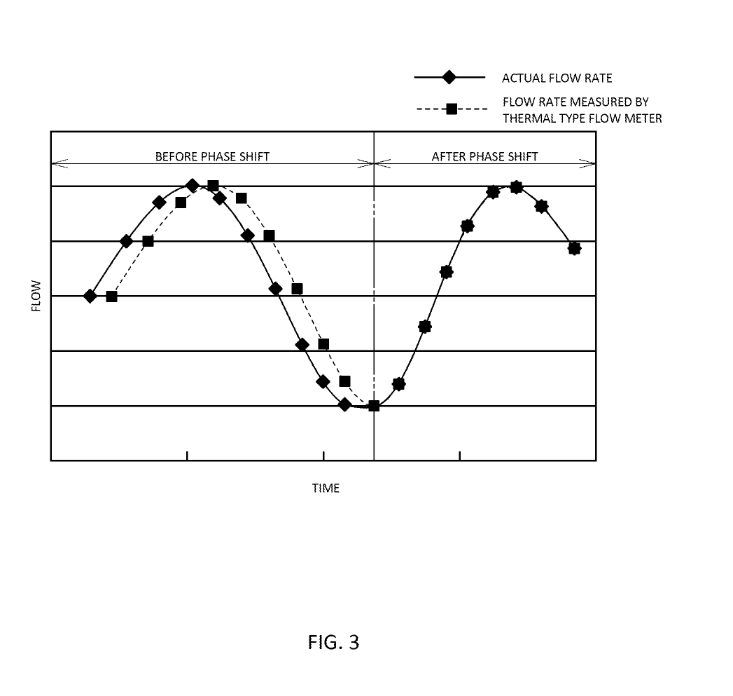

The flow sensor inspecting part 53 is intended to compare the reference flow rate value calculated by the reference flow rate calculation part 52 and the measurement flow rate value outputted from the inspection target flow sensor FS and detect a time delay of the inspection target flow sensor FS to thereby adjust the time delay to be zero. More specifically, as shown by a graph in FIG. 3, the flow sensor inspecting part 53 is configured to change the differential coefficient so that the phase difference between the time series data of the measurement flow rate value outputted from the inspection target flow sensor FS and the time series data of the measurement flow rate value measured by the fluid sensor becomes zero.

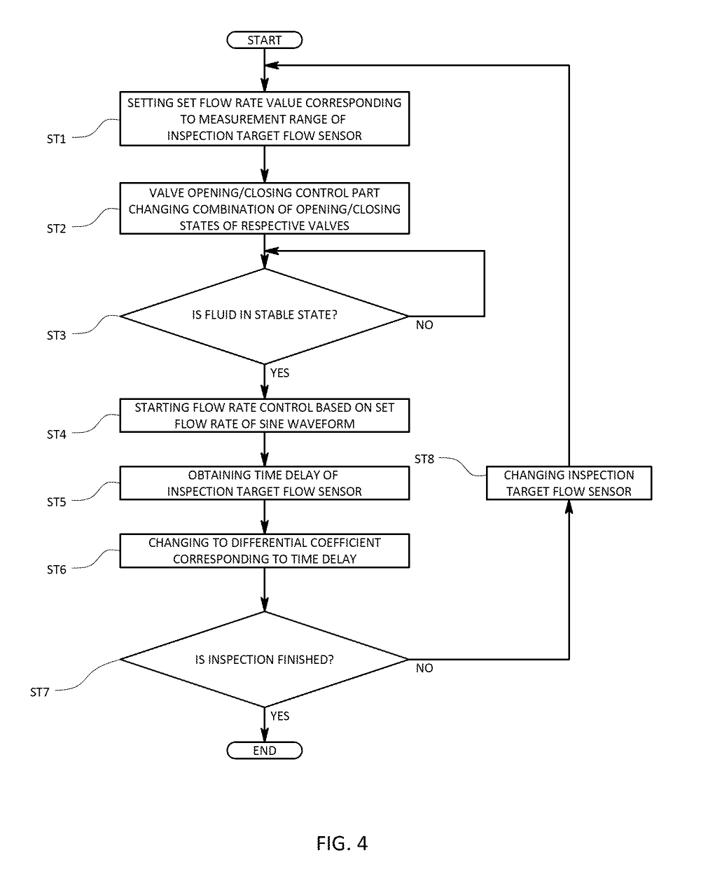

The following describes an operation during the adjustment of the differential coefficient in the inspection target flow sensor FS by the flow sensor inspection system 100 configured as described above with reference to the flowchart in FIG. 4.

First, the set flow rate value SET corresponding to a measurement range of the inspection target flow sensor FS is set. This set flow rate value SET may be set by a user or may be automatically set by the information processing unit 5 by obtaining such as, for example, a type of the flow sensor (Step ST1).

Next, the valve opening/closing control part 51 determines and changes the combination of the opening/closing states of the respective valves Va, Vb and Vc in accordance with an amount of the set flow rate value SET and a kind of the fluid flowing in the flow path. For example, in the case where the set flow rate value SET is set within a small flow rate range, the valve opening/closing control part 51 controls all the valves Va, Vb and Vc to be opened so that the fluid flows in the respective inspection lines and minimizes the value of the fluid resistance to the gas supply line. Further, in the case where the set flow rate value SET is set within a middle flow rate range, the valve opening/closing control part 51 controls two of the valves Va, Vb and Vc to be opened, and in the case where the set flow rate value SET is set within a large flow rate range, the valve opening/closing control part 51 controls only one of the valves Va, Vb and Vc to be opened so that the value of the fluid resistance is increased. As a result of this, the value of the pressure is adjusted in correspondence with the set flow rate value SET so as to allow the fluid to be in a stable state (Step ST2).

Then the fluid flows in a region between the inspection target flow sensor FS and the respective laminar flow elements Ra, Rb and Rc, while the processing step proceeds in a state of waiting until the pressure is charged to thereby allow the fluid to be in a stable state (Step ST3). After the fluid is allowed to be in a stable state, the flow rate control executed by the flow rate control valve 24 is started so that the actual flow rate follows the set flow rate of a sine waveform (Step ST4).

The flow sensor inspecting part 53 obtains a phase difference indicating a time delay based on a sine wave drawn by the time series data of the reference flow rate value calculated based on the pressures measured by the upstream side pressure sensor P1 which is a fluid sensor to be referenced and the downstream side pressure sensor P2 and a sine wave drawn by the time series data of the measurement flow rate value outputted from the inspection target flow sensor FS (Step ST5).

Subsequently, the flow sensor inspecting part 53 adjusts a differential coefficient set in the flow rate output part 22 so that the obtained phase difference becomes zero and advances the phase to thereby bring the measurement flow rate value into coincidence with the reference flow rate value (Step ST6).

Then, it is determined whether or not the inspections of all the inspection target flow sensors FS provided on the respective gas supply lines 1a to 1e have been finished (Step ST7). In the case of not being finished, another inspection target flow sensor FS and the gas supply line 1 are connected (Step ST8), and the processes in Steps ST1 to ST7 are repeated.

As described above, according to the flow sensor inspection system 100 of the present embodiment, since there is configured the fluid resistance adjustment mechanism FR which includes: the valves Va, Vb and Vc; and the laminar flow elements Ra, Rb and Rc respectively provided on the plurality of branch flow paths provided in parallel, the pressure allowing the fluid to be in a stable state can be changed by changing the combination of the opening/closing states of the valves Va, Vb and Vc.

Further, in the case where the measurement range of the inspection target flow sensor FS is a small flow rate range and the set flow rate value SET is small, for example, the valves Va, Vb and Vc are opened so that the flow of the fluid is stabilized at a low pressure. Therefore, even though the flow rate of the fluid flowing in a region between the inspection target flow sensor FS and the respective laminar flow elements Ra, Rb and Rc is small, it becomes possible to charge up to a pressure capable of starting the inspection in a short time and the waiting time required until the inspection is started can be remarkably reduced.

On the other hand, in the case where the measurement range of the inspection target flow sensor FS is a large flow rate range, the number of the opened valves among the valves Va, Vb and Vc is reduced and the value of the fluid resistance is increased to thereby increase the pressure for stabilizing the fluid. As a result of this, it is possible to suppress occurrence of such as a noise in the measurement flow rate value outputted from the inspection target flow sensor FS even in the large flow rate range. Thus, the inspection of a time delay can be accurately performed.

Other embodiments are described below.

In the previous described embodiment, although three branch flow paths (3a, 3b, 3c) are provided as shown in FIG. 2, it is sufficient that two or more branch flow paths are provided. Further, although the inspection system is configured using a configuration including a flow rate control device, it may be also possible to use, for example, a plurality of parallel branch flow paths and a fluid resistance adjustment device including valves and fluid resistances respectively provided on the branch flow paths. Further, regarding the valves, those having only the opening/closing degrees controllable or having the opening degrees thereof freely adjustable may be also used. Also, regarding the laminar flow elements, the other elements can be used so long as the elements act as fluid resistances.

In the previous described embodiment, although the adjustment of a time delay of an inspection target flow sensor is also performed in the inspection of the flow sensor, it may be sufficient to only check whether or not a time delay is present, as the inspection. That is, in the present description, the inspection of a time delay implies that at least one of the check or adjustment of a time delay is performed. Further, it is not necessary to automate all of the inspections but, for example, only the determination and execution of the combination of the opening/closing states of the respective valves to be set at the time of inspecting a time delay may be automatically performed by the information processing unit, and a determination of presence or absence of a time delay and adjustment work may be performed by a user per se.

The respective laminar flow elements may have all the same characteristics or may have different characteristics. In the case where the characteristics of the respective laminar flow elements are different, the values of the fluid resistances to the gas supply line which is the upstream side flow path can be changed also by a permutation of the opening/closing states of the respective valves, and the pressure in the inspection of a time delay can be more precisely set.

In the previous described embodiment, although the flow rate values are compared for adjusting a time delay of the inspection target flow sensor, it is also possible to use a pressure sensor as a fluid sensor and compare the time series data of the pressure value thereof and the time series data of the measurement flow rate value outputted from the inspection target flow sensor to thereby perform an adjustment related to a time delay. The reason why the subjects having different units like this can be compared is because it is sufficient to understand a waveforms indicating the respective time series data and the time delay can be adjusted so long as even the phase difference can be accurately obtained. For the same reason, it is not necessary that the reference measurement flow rate value or pressure value is coincident with the actual flow rate or actual pressure of the fluid. Therefore, the valve opening/closing control part may be configured to change the combination of the opening/closing states of the respective valves so that the pressure in the upstream side flow path becomes lower than a recommended use pressure which the fluid sensor can output a measurement value approximately equal to the actual pressure or actual flow rate of the fluid. With this configuration, the time required until the pressure is charged can be further reduced and the time required for inspecting a time delay can be further reduced.

Further, in the previous described embodiment, although the sine waveform set flow rate value SET is used for obtaining a time delay, any other waveforms may be used. For example, a time delay can be adjusted using time series data of a primary response, and the set flow rate value SET may be changed stepwise. In short, it may be sufficient so long as the flow rate is variable to thereby able to obtain a time delay. Further, in the embodiment, although the time delay is adjusted in a sine waveform of a specific frequency, for example, by performing a frequency sweep, an adjustment working of such as differential coefficient can be performed so that a phase lag substantially disappears in a predetermined band. Moreover, the valve opening/closing control part may be configured to control the number of opening or closing valves in accordance with the measurement rage of the inspection target flow sensor without using the set flow rate value. For example, in the case where the measurement range is large, the number of the opening valves is reduced and the number of the closing valves is increased to thereby stabilize the flow of the fluid at a high pressure. In the case where the measurement range is small, the flow of the fluid may be stabilized by increasing the number of the opening valves.

In the previous described embodiment, although the inspection target flow sensor for inspecting a time delay is provided in the upstream side flow path while the reference fluid sensor is provided on the branch flow path, the inspection target flow sensor may be is provided on the branch flow path and the reference fluid sensor may be provided on the upstream side flow path. In short, it is sufficient that the inspection target flow sensor is provided in the flow path structure and also the fluid sensor is provided in the flow path structure similarly.

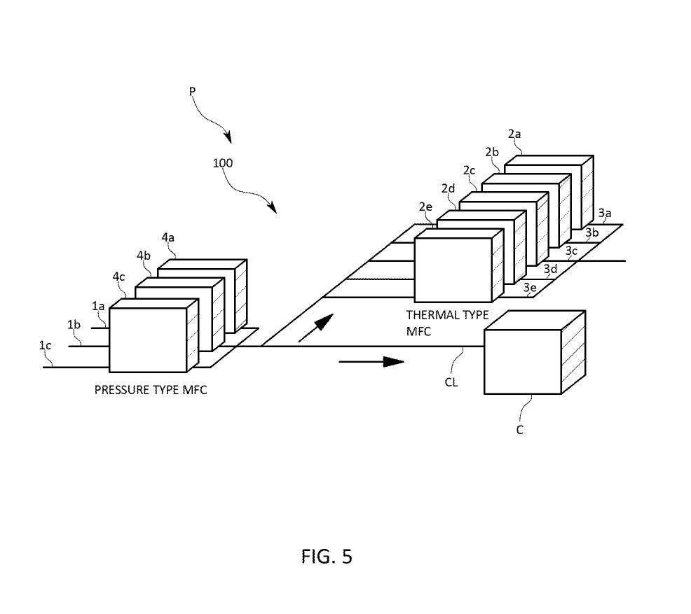

More specifically, as shown in FIG. 5, the arrangement of the inspection target flow rate control devices 2 and the reference flow rate control devices 4 may be interchanged in placement with that of the previous described embodiment shown in FIG. 1. That is, the inspection system 100 may be configured in such a manner that, each reference flow rate control device 4 is provided on the gas supply line 1 which serves as the upstream side flow path and each inspection target flow rate control device 2 is provided on the inspection line 3 which serves as the branch flow path. The following describes in detail another embodiment of such an inspection system 100. Note that members or parts corresponding to those in the previous described embodiment are denoted by the same reference numerals.

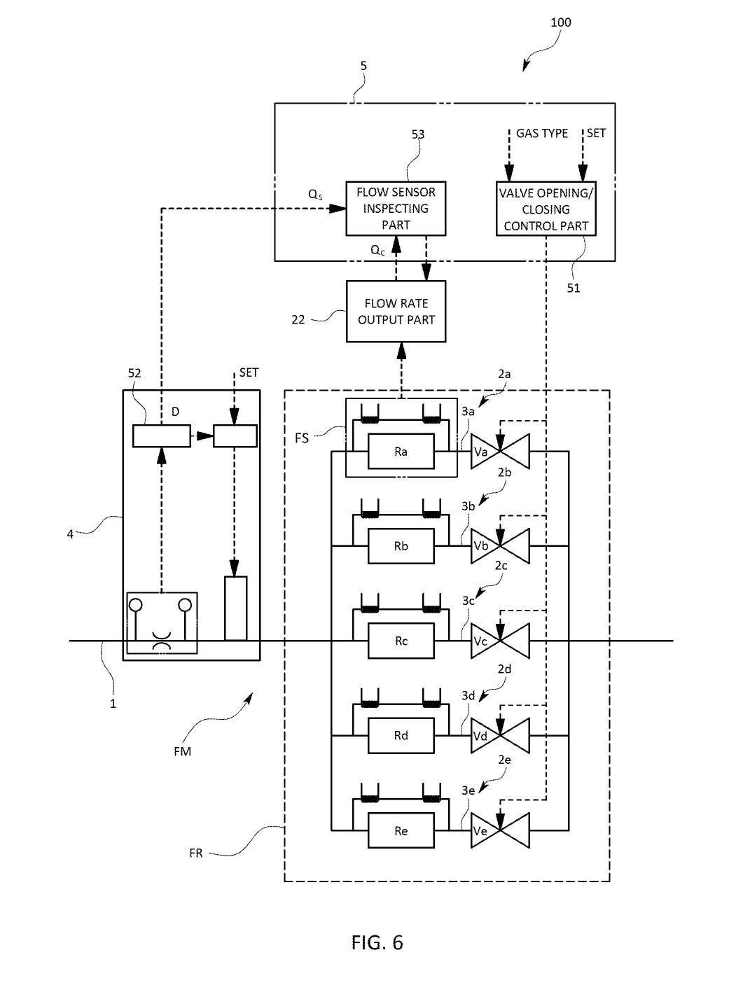

As shown in FIG. 6 extracting only the inspection system 100 in FIG. 5, in the inspection system 100 of this embodiment, the reference flow rate control device 4 which serves as a pressure type mass flow controller is arranged on the gas supply line 1 and the inspection target flow rate control devices 2a to 2e each serving as a thermal type mass flow controller are respectively provided on a plurality of inspection lines 3 formed of the branch flow paths. Note that, FIG. 6 shows a configuration of inspecting a time delay in the case where a thermal type flow sensor of the inspection target flow rate control device 2a is exemplified as the inspection target flow sensors FS.

In the this embodiment, a valve opening/closing control part 51 is configured to control a combination of opening/closing states of valves Va to Ve of inspection target flow rate control devices 2a to 2e in accordance with, for example, a measurement range of the flow sensor FS in the case of starting an inspection of a time delay. Especially, in the case where the measurement range is small, the valve opening/closing control part 51 opens at least two or more valves among the valves Va to Ve. That is, in this embodiment, capillaries and dividing elements Ra to Re provided with windings in the thermal type flow sensors in the inspection target flow rate control devices 2a to 2e are used as the fluid resistances, and by determining which valve among the valves Va to Ve should be opened, it is intended to be able to change as to which of the valves acts in the flow path structure FM.

Further, in the case of inspecting a time delay of an inspection target flow sensor without obtaining such as a set flow rate value, a kind of gas and a measurement range, the valve opening/closing control part may be configured to open two or more valves. In addition, the valve opening/closing control part may be configured to control the number of valves to be opened in accordance with only the kind of gas.

In the previous described embodiments, although the inspection target flow sensor is a thermal type flow sensor and the reference fluid sensor is a pressure type flow sensor, it may be also possible to use a pressure type flow sensor as the inspection target flow sensor and use a thermal type flow sensor as the reference fluid sensor. Further, the measurement principles of the inspection target flow sensor and the reference fluid sensor should not be limited to pressure type or thermal type one, and sensors using various measurement principles such as ultrasonic one may be also used.

Further, the positional relationship between the valve and the fluid resistance provided on each of the branch flow paths should not be limited to that shown in the previous described embodiments. That is, the valve may be provided on any of the upstream side or downstream side with respect to the fluid resistance. It is not limited that the fluid resistances are realized by means of providing a laminar flow elements or dividing elements, and there may be used a resistance realized by, for example, a length, material and surface shape of the branch flow path per se. That is, instead of arranging the member on the branch flow path as the fluid resistance, a desired fluid resistance may be realized by using such as a shape or characteristics of the branch flow path per se without arranging anything on the branch flow path.

The branch flow path in the present description may be configured by providing at least one pair of the valve and the fluid resistance and there may be provided such as a passing flow path having no valve and fluid resistance, in parallel with the branch flow path. That is, it is not necessary to provide the valves and fluid resistances on all the branch flow paths branched in the downstream of the upstream side flow path.

With these configurations, even in the case where a flow rate of the fluid flowing from the upstream into the flow path structure is small, the state of the flow of the fluid can be stabilized at a low pressure, and there can be exhibited an effect that the inspection of a time delay can be started in a short time.

In addition, it should not be limited to a valve provided in the vicinity of the inspection target flow sensor for causing a change of the flow rate in the flow path structure. For example, it may be also configured to control a flow rate by a valve provided not on the upstream side flow path but on the branch flow path to thereby calibrate a time delay of an inspection target flow sensor.

Note that, when describing the previous described embodiment shown in FIG. 1 in another way, the present invention is an inspection system used for inspecting a time delay of a measurement flow rate value outputted from an inspection target flow sensor. The inspection system includes: fluid resistances respectively provided with respect to a plurality of branch flow paths branched in the downstream of the upstream side flow path provided with the inspection target flow sensor; valves respectively provided with respect to the branch flow paths; a flow sensor of which at least a part is provided in the upstream side of each of the fluid resistances and which measures a pressure or a flow rate of the fluid; and a valve opening/closing control part configured to allow a plurality of the valves to be in opened states at the time of inspecting the inspection target flow sensor based on the output of the fluid sensor.

It is needless to say that various modifications of the embodiments can be made in a range without departing from the spirit thereof.

### REFERENCE SIGNS LIST

P . . . Semiconductor manufacturing apparatus
1 . . . Gas supply line (upstream side flow path)
2 . . . Inspection target flow rate control device
FS . . . Inspection target flow sensor
21 . . . Sensing mechanism
22 . . . Flow rate output part
23 . . . Flow rate control part
24 . . . Flow rate control valve
3 . . . Inspection line (branch flow path)
4 . . . Reference flow rate control device
P1 . . . Upstream side pressure sensor
V . . . Valve
R . . . Laminar flow element (fluid resistance)
P2 . . . Downstream side pressure sensor
FR . . . Fluid resistance adjustment mechanism

1. An inspection method of a flow sensor for inspecting a time delay of a measurement flow rate value outputted from the inspection target flow sensor provided in a flow path structure equipped with an upstream side flow path and a plurality of branch flow paths branched in a downstream of the upstream side flow path, using:
fluid resistances respectively provided for the respective branch flow paths; valves respectively provided for the respective branch flow paths; and a fluid sensor for measuring a pressure or a flow rate of fluid in the flow path structure,
wherein the inspection method comprises a valve control step to allow a plurality of the valves to be in opened states at the time of inspecting the inspection target flow sensor based on the output of the fluid sensor.

2. An inspection system of a flow sensor used for inspecting a time delay of a measurement flow rate value outputted from the inspection target flow sensor provided in a flow path structure equipped with an upstream side flow path and a plurality of branch flow paths branched in a downstream of the upstream side flow path, comprising:
fluid resistances respectively provided for the respective branch flow paths;
valves respectively provided for the respective branch flow paths;
a fluid sensor for measuring a pressure or a flow rate of fluid in the flow path structure; and
a valve opening/closing control part configured to allow a plurality of the valves to be in opened states at the time of inspecting the inspection target flow sensor based on the output of the fluid sensor.

3. The inspection system of the flow sensor according to claim 2, wherein the valve opening/closing control part is configured to change a combination of the opening/closing states of the respective valves in accordance with a set flow rate value which is a target value of the flow rate of the fluid flowing at least in the flow path structure.

4. The inspection system of the flow sensor according to claim 2, wherein the valve opening/closing control part is configured to change a combination of the opening/closing states of the respective valves in a manner that, the smaller the set flow rate value is, the smaller the pressure of the fluid in the flow path structure becomes.

5. The inspection system of the flow sensor according to claim 2, further comprising a flow sensor inspecting part that is configured to inspect the time delay of the measurement flow rate value outputted from the inspection target flow sensor, based on time series data of the measurement flow rate value outputted from the inspection target flow sensor and time series data of a measurement value of a pressure or a flow rate outputted from the fluid sensor.

6. The inspection system of the flow sensor according to claim 5, wherein the inspection target flow sensor is equipped with a sensing mechanism that is configured to output an electric signal corresponding to the flow rate of the fluid and a flow rate output part that is configured to output a measurement flow rate value based on a value indicated by the electric signal outputted from the sensing mechanism and a predetermined flow rate calculation formula,
wherein the flow rate calculation formula includes a term of a product of a differential value indicated by the electric signal outputted from the sensing mechanism and a differential coefficient which is a coefficient to be multiplied with the differential value, and
wherein the flow sensor inspecting part is configured to change the differential coefficient so that a phase difference between the time series data of the measurement flow rate value outputted from the inspection target flow sensor and the time series data of a measurement value measured by the fluid sensor becomes zero.

7. The inspection system of the flow sensor according to claim 2, wherein the inspection target flow sensor is a thermal type flow sensor, and the fluid sensor is a pressure flow sensor.

8. A program recording medium with a program for an inspection system of a flow sensor recorded thereon, the program used for inspecting a time delay of a measurement flow rate value outputted from the inspection target flow sensor provided in a flow path structure equipped with an upstream side flow path and a plurality of branch flow paths branched in a downstream of the upstream side flow path, and used for the inspection system of the flow sensor, the inspection system comprising: fluid resistances respectively provided for the respective branch flow paths; valves respectively provided for the respective branch flow paths; and a fluid sensor for measuring a pressure or a flow rate of fluid in the flow path structure,
wherein the program allows a computer to exhibit a function as a valve opening/closing control part configured to allow a plurality of the valves to be in opened states at the time of inspecting the inspection target flow sensor based on the output of the fluid sensor.
